(19) United States
(12) Patent Application Publication
(10) Pub. No.: US 2009/0233171 A1
(43) Pub. Date: Sep. 17, 2009

(54) Process to Produce Electrode Sheet

(76) Inventor: Shinji Naruse, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/226,727

(22) PCT Filed: Mar. 20, 2007
(86) PCT No.: PCT/JP2007/056519

§ 371 Date: Oct. 27, 2008

(30) Foreign Application Priority Data
Apr. 27, 2006 (JP) 2006-123961

(51) Int. Cl. H01M 4/02; B05D 5/12; H01G 9/04

(52) U.S. Cl. 429/209; 427/58; 361/502

(57) ABSTRACT

This invention provides a method to produce an electrode sheet adaptable to high-temperature drying and to charge and discharge under high voltage, by coating a collector with a slurry which comprises electrode active material, electroconductive agent, binder and solvent, and then drying the same, wherein meta-aramid is used as binder, and wherein thus dried electrode sheet is compressed.

### TECHNICAL FIELD

This invention relates to a process to produce electrode sheet which is useful for constituting an electrode of electrical and electronic parts such as capacitors and lithium secondary batteries.

### BACKGROUND ART

As symbolized by the recent progress in electronic instruments such as portable communication devices or high-speed information processors, the reduction in size and weight and the advance in technical performance of electronic instruments are splendid. Above all, more expectation is being placed on high-performance capacitors and batteries which have small size, light weight and high capacity, and which can withstand storage over a prolonged period. Thus, their application range is being broadened, and developments of parts for them are under rapid progress.

Correspondingly, there are growing needs also for developing technique and quality for binders with which to bind electrode active material in an electrode sheet. Among various properties required for binders, the following three are recognized to be particularly important:
1) that they exhibit high bondability for electrode active material;
2) that they have good electrical conductivity in the state where electrode active material is bound, i.e., in an electrode sheet; and
3) that they have good wettability to electrolyte in the state where electrode active material is bound, i.e., in an electrode sheet.

Conventionally, as a raw material for binders, there have been widely used PVdF (polyvinylidene fluoride), PTFE (polytetrafluoroethylene), SBR (styrene-butadiene rubber) latex, and the like.

On the other hand, as a means to provide active material for negative electrode of secondary batteries which may show a high charge-discharge efficiency, Official Gazette of Japanese Patent Application KOKAI Publication No.2001-345103 (EP 1 274 141 A1; US 2003/049535 A1) discloses the use of aramid (aromatic polyamide) as a negative electrode active material-cum-binder for secondary batteries which are formed from, as a part of negative electrode active material, an organic high polymer which has an electrochemically active carbonyl group on its main chain or side chain. In this Official Gazette of Japanese Patent Application KOKAI Publication No. 2001-345103, however, meta-aramid and para-aramid are not definitely distinguished from each other, and, also as to production method, it is only mentioned that a material which is to serve as negative electrode active material is mixed with aramid, applied onto a collector metal and dried; no reference is made to compressing, after drying, an electrode sheet which is made with aramid as a binder.

### DISCLOSURE OF THE INVENTION

Electrode sheets which are made with the above-mentioned binders such as PVdF (polyvinylidene fluoride), PTFE (polytetrafluoroethylene) and SBR (styrene-butadiene rubber) latex possess favorable physical properties, but do not necessarily fully meet either recent demands for high voltage-resistance, high capacity and high power output which are being made with respect to capacitors or batteries of electric cars, or high-temperature drying of electrode group which comprises a collector, an electrode and a separator (Japanese Patent Application No. 2006-073898; PCT/JP2006/326174) which the inventors of the present invention have previously proposed as a measure to achieve the above-mentioned properties.

It is generally understood that a binder in electrode sheet in electrical and electronic parts such as capacitors, batteries and the like which are required to have high voltage-resistance, high capacity and large power output must simultaneously satisfy the following five property requirements:
1) high bondability for electrode active material;
2) good electrical conductivity in the state where electrode active material is bound, i.e., in an electrode sheet;
3) good wettability to electrolyte in the state where electrode active material is bound, i.e., in an electrode sheet;
4) high thermal resistance; and
5) good electrochemical stability.

In particular, heat resistance is important for the high-temperature drying of electrode group which comprises a collector, an electrode and a separator. Furthermore, good electrochemical stability is considered to be extremely important for the sake of prevention of decrease of capacity and of power output in charge and discharge under high voltage in electrical and electronic parts like capacitors and batteries which are to be used under high current, for instance, as drive power source of electric cars.

Under the aforementioned circumstances, the present inventors have engaged in concentrative studies with a view to developing a highly heat-resistant electrode sheet which may withstand higher voltage-resistance, higher capacity and larger power output, and have so completed the present invention.

Thus, the present invention provides a method to produce an electrode sheet by coating a collector with a slurry which comprises electrode active material, electroconductive agent, binder and solvent, and then drying the same, which method is characterized in that meta-aramid is used as a binder, and that thus dried electrode sheet is compressed.

The electrode sheet which is provided by the method of the present invention has high heat-resistance and also sufficiently high packing rate of electrode active material, is capable of high-temperature drying since meta-aramid which is electrochemically stable is used as a binder, and thus can be advantageously used for electrode sheets of high voltage-resistant electrical and electronic parts such as capacitors and batteries. Moreover, electrical and electronic parts such as capacitors and batteries which are made with electrode sheet manufactured by the method of this invention can be used even under high-voltage and high-current conditions as in electric cars, and are therefore quite useful.

This invention is explained below in more detail.

### Electrode Active Material:

There is no particular restriction on raw material for electrode active material which is to be used in this invention, so long as it functions as an electrode of capacitors and/or batteries. There can be specifically mentioned, in the case of capacitor, carbon materials such as activated carbon, foamy carbon, carbon nanotube, polyacene and nanogate carbon which are used for an electrical double layer capacitor and so on that store electricity by utilizing electrical double layer which was discovered by Helmholtz in 1879; metal oxides which can also serve as pseudo-capacitance that accompanies oxidation-reduction reactions; electroconductive polymers; organic radicals and so on. In the case of batteries, in particular lithium ion secondary batteries, metal oxides of lithium and so on such as lithium cobalt oxide, lithium chromate, lithium vanadium oxide, lithium nickel oxide and lithium manganese oxide can be used for positive electrode. For negative electrode, there can be used carbon materials such as natural graphite, artificial graphite, resinous charcoal, carbide of natural products, petroleum coke, coal coke, pitch coke and Mesocarbon micro beads; metal lithium and so on.

### Electroconductive Agent:

In this invention, there is no particular restriction on electroconductive agent so long as it has a function to improve electrical conductivity of electrode sheet. Preferably used is, for instance, carbon black such as acetylene black and ketchenblack, and so on.

### Meta-Aramid:

In this invention, meta-aramid means linear high polymer aromatic polyamide compounds wherein 60% or more of amide bonds are formed directly on aromatic ring at meta-positions. Specifically included are polymetaphenylene isophthalamide and its copolymer and so on. These meta-aramids have been industrially manufactured by known interfacial polymerization method with isophthalic acid chloride and metaphenylene diamine, solution polymerization, or the like, and are available on the market. Meta-aramid in this invention is, however, not limited to them. Among these meta-aramids, polymetaphenylene isophthalamide is in particular preferably employed due to its good special properties such as processability, heat bondability, flame resistance and heat resistance.

### Solvent:

In this invention, there can be used any solvent without restriction so long as it can dissolve meta-aramid. In particular preferable is either N,N-dimethylacetamide (DMAC) or N-methyl-2-pyrrolidone (NMP), or also a mixture thereof.

### Collector:

In this invention, there is no restriction on collector so long as it is made from electroconductive material and is stable against electrode, solvent and electrolyte. Concrete examples include metal thin sheet such as aluminum thin sheet, platinum thin sheet and copper thin sheet.

### Glass Transition Temperature:

In this specification, glass transition temperature is a value which is obtained in the following manner: the temperature of a test piece is increased from room temperature at a rate of 3° C./minute; exotherm is measured with a differential scanning calorimeter; two extension lines are drawn from endothermic curve; and the point at which a ½ straight line between the extension lines intersects the endothermic curve gives the value of glass transition temperature. Polymetaphenylene isophthalamide has a glass transition temperature of 275° C.

### How to Produce Electrode Sheet:

### 1) Step for the Preparation of Slurry:

Meta-aramid is dissolved in a solvent beforehand to give a meta-aramid solution. Then, this solution is mixed with electrode active material and electroconductive agent. Agitation of the resultant mixture gives a uniform slurry.

### 2) Step for the Formation of a Thick Sheet:

Thus prepared slurry is applied onto either one side or both sides of collector with a slurry-applying device such as doctor knife. Thus coated collector is dried and solidified either being passed through a continuous drying oven or in a stationary drying oven, to give a thick sheet. Drying temperature is preferably within a range of ±5° C. from the boiling point of solvent, which is not restrictive however.

### 3) Step for Compression:

Thus formed sheet is compressed (heat-pressed) at high temperature and high pressure between, for instance, a pair of flat plates or metal-made rolls so that the sheet may be improved in density and mechanical strength. Electrode sheet after compression preferably satisfies inequality (1) as follows:

0.25<D×(1/D−We/De−Wc/Dc−Wb/Db)<0.75 (1)

in particular,

0.40<D×(1/D−We/De−Wc/Dc−Wb/Db)<0.75

wherein:
D is the density of electrode sheet except collector sheet;
We is the weight fraction of electrode active material;
De is the true specific gravity of electrode active material;
Wc is the weight fraction of electroconductive agent;
Dc is the true specific gravity of electroconductive agent;
Wb is the weight fraction of binder; and
Db is the true specific gravity of binder.

When D×(1/D−We/De−Wc/Dc−Wb/Db) is 0.75 or more, electrode sheet does not have high enough a density, and is hard to give sufficient capacity for capacitor or battery. When, reversely, D×(1/D−We/De−Wc/Dc−Wb/Db) is 0.25 or less, electrode sheet has too high a density, and is hard to give sufficient power output for battery.

Compression (heat-pressing) is conducted, when metal-made roll is used, at a temperature of 200-400° C., preferably 280-370° C., and at a linear pressure of 50-400 kg/cm, preferably 100-400 kg/cm, which ranges are, however, not restrictive. In order that high capacity and high power output may be realized for capacitor and battery, compression is desirably conducted at glass transition temperature of meta-aramid or higher, in particular at a temperature which is higher, by 10-90° C., than the glass transition temperature of meta-aramid.

It is also possible to lower the glass transition temperature of meta-aramid by making the same contain a solvent before compression, and thereby plasticizing the same.

The above-mentioned plasticization can be achieved by lowering drying temperature at drying process in the above-mentioned step for the formation of a thick sheet and thereby keeping the solvent from fully evaporating, or by spraying a solvent on the above-mentioned thick sheet. These methods are, however, not restrictive.

Compression can also be carried out at room temperature without heat operation. Otherwise, the aforementioned heat-pressing process can be repeated several times. Furthermore, the formed sheet may be passed through a continuous drying oven again or dried in a stationary drying oven again after the aforementioned heat-pressing process. The above-mentioned heat-pressing process and the above-mentioned drying can be repeated in any order at any number of times.

### EXAMPLES

In the following, this invention is explained in more detail by working examples. These Examples are, however, only given for illustrative purpose, and are not intended to limit this invention in any sense.

### Method of Measurement:

(1) Measurement of the basis weight and the thickness of sheet JIS C2111 was followed. The part of collector was deducted.
(2) Measurement of Electrical Conductivity

A direct current of nine volts was applied to a sample of electrode sheet of this invention of a size of 5 cm×5 cm which had been compressed toward thickness direction at a pressure of 2 kgf/cm². The value of resistance R (Ω) was measured with a tester from the value of current after 30 seconds. Electrical conductivity C was calculated according to the following formula:

C=(Thickness of sample: cm)/25 R

### Referential Example

### Preparation of Electrode Sheet

1) Step for the Preparation of Slurry:

Polymetaphenylene isophthalamide (true specific gravity: 1.38) was dissolved in NMP to give a meta-aramid solution. Then, this solution was mixed with activated carbon (true specific gravity: 2.0) and ketchenblack (true specific gravity: 2.2). Agitation of the resultant mixture gave a uniform slurry. Mixing ratio was adjusted to achieve a weight ratio of activated carbon:ketchenblack:polymetaphenylene isophthalamide=85:5:10, after NMP had been evaporated.
2) Step for the Formation of a Thick Sheet:

Slurry as prepared in the above was applied onto one side of aluminum foil-made collector (with electroconductive anchor applied) with a doctor knife. Thus coated collector was passed through a continuous drying oven at a drying temperature of 200° C. to give a thick sheet.

### Example 1

The thick sheet as formed in Referential Example was heat-pressed between a pair of metal-made rolls at a temperature of 330° C. which is not lower than the glass transition temperature of polymetaphenylene isophthalamide (275° C.), and at a linear pressure of 300 kgf/cm, to give an electrode sheet as shown in Table 1.

### Comparative Example 1

The thick sheet as formed in Referential Example was heat-pressed between a pair of metal-made rolls at a temperature of 20° C. and at a linear pressure of 300 kgf/cm to give an electrode sheet as shown in Table 1.

Main special property values of electrode sheets as obtained in Example 1 and Comparative Example 1 are shown in Table 1.

TABLE 1

| | | | | Comparative |
|---|---|---|---|---|
| Property | Unit | Thick sheet | Example 1 | Example 1 |
| Basis weight | g/m² | 57.4 | 57.4 | 57.4 |
| Thickness | μm | 205 | 108 | 151 |
| Density | g/cm³ | 0.28 | 0.53 | 0.38 |
| A | | 0.854 | 0.724 | 0.802 |
| Electrical | S/cm | 5 × 10⁻² | 1 × 10⁻¹ | 3 × 10⁻² |
| conductivity | | | | |

In Table 1, A denotes D×(1/D−We/De−Wc/Dc−Wb/Db), in which D, We, De, Wc, Dc, Wb and Db are as defined above.

As is evidently seen in Table 1, the electrode sheet of Example 1 has high enough a density, a value of D×(1/D−We/De−Wc/Dc−Wb/Db) which falls in a suitable range, a high electrical conductivity. Furthermore, since meta-aramid which is highly heat-resistant and electrochemically stable is used as a binder, the electrode sheet of Example 1 is capable of high-temperature drying, and is quite useful as an electrode sheet for electrical and electronic parts such as highly voltage-resistant capacitors and batteries.

1. A method to produce an electrode sheet by coating a collector with a slurry which comprises electrode active material, electroconductive agent, binder and solvent, and then drying the same, which method is characterized in that meta-aramid is used as binder, and that thus dried electrode sheet is compressed.

2. The method of claim 1 wherein meta-aramid is dissolved in a solvent beforehand, thus obtained solution is mixed with electrode active material and electroconductive agent to give a slurry, and then a collector is coated with said slurry, dried and is compressed.

3. The method of claim 1 wherein, after dried, the collector is compressed at glass transition temperature of meta-aramid or higher.

4. The method of any one of claim 1 wherein, before the collector is compressed, meta-aramid is made to contain a solvent, to be thereby plasticized, and to thus lower its glass transition temperature.

5. The method of claim 1 wherein meta-aramid is polymetaphenylene isophthalamide.

6. The method of claim 1 wherein the solvent is N,N-dimethylacetamide, N-methyl-2-pyrrolidone or a mixture thereof.

7. An electrode sheet produced by the method of claim 1, which satisfies inequality (1) as follows:
0.25<D×(1/D−We/De−Wc/Dc−Wb/Db)<0.75 (1)
wherein:
D is the density of electrode sheet except collector sheet;
We is the weight fraction of electrode active material;
De is the true specific gravity of electrode active material;
Wc is the weight fraction of electroconductive agent;
Dc is the true specific gravity of electroconductive agent;
Wb is the weight fraction of binder; and
Db is the true specific gravity of binder.

8. Electrical and electronic parts which are made with the electrode sheet of claim 7.

9. Capacitors which are made with the electrode sheet of claim 7.

10. Batteries which are made with the electrode sheet of claim 7.
